(19) United States
(12) Patent Application Publication
(10) Pub. No.: US 2016/0171575 A1
(43) Pub. Date: Jun. 16, 2016

(54) METHODS AND SYSTEMS FOR IDENTIFYING MOBILE PHONES AND OTHER ELECTRONIC DEVICES

(71) Applicant: ecoATM, Inc., San Diego, CA (US)

(72) Inventors: Mark Vincent Bowles, San Diego, CA (US); John Silva, San Diego, CA (US); Christopher Ray Dawson, San Diego, CA (US)

(21) Appl. No.: 14/568,051

(22) Filed: Dec. 11, 2014

(51) Int. Cl. G06Q 30/06

(52) U.S. Cl. CPC G06Q 30/0611

(57) ABSTRACT

The present disclosure describes various embodiments of methods and systems for identifying a device that is being offered for purchase from a user at a kiosk. In some embodiments, the kiosk queries a database to determine or corroborate the type of equipment being offered for purchase based on an unique identifier such as an IMEI/MEID number or a TAC code for the device. In one embodiment the database may be a database created by a governing organization that associates IMEI/MIED numbers with particular equipment types. In another embodiment, a database stores records of transactions involving particular types of equipment and TAC numbers associated with the types of equipment used in the transaction.

### TECHNICAL FIELD

The present disclosure is directed generally to methods and systems for recycling mobile phones and other consumer electronic devices and, more particularly, to methods and systems associated with identifying such devices.

### BACKGROUND

Consumer electronic devices, such as mobile phones, laptop computers, notebooks, tablets, MP3 players, etc., are ubiquitous. Currently there are over 6 billion mobile devices in use in the world; and this number is growing rapidly as more than 1.8 billion mobile phones were sold in 2013 alone. By 2017 it is expected that there will be more mobile devices in use than people on the planet. In addition to mobile phones, over 300 million desk-based and notebook computers shipped in 2013, and for the first time the number of tablet computers shipped exceeded laptops. Part of the reason for the rapid growth in the number of mobile phones and other electronic devices is the rapid pace at which these devices evolve, and the increased usage of such devices in developing countries.

As a result of the rapid pace of development, a relatively high percentage of electronic devices are replaced every year as consumers continually upgrade their mobile phones and other electronic devices to obtain the latest features or a better operating plan. According to the U.S. Environmental Protection Agency, consumers in the United States alone dispose of over 370 million mobile phones, PDAs, tablets, and other electronic devices every year. Millions of other outdated or broken mobile phones and other electronic devices are simply tossed into junk drawers or otherwise kept until a suitable disposal solution arises.

Although many electronic device retailers and cell carrier stores now offer mobile phone trade-in or buyback programs, many old mobile phones still end up in landfills or are improperly disassembled and disposed of in developing countries. Mobile phones and similar electronic devices, however, typically contain substances that can be harmful to the environment, such as arsenic, lithium, cadmium, copper, lead, mercury and zinc. If not properly disposed of, these toxic substances can seep into groundwater from decomposing landfills and contaminate the soil with potentiality harmful consequences for humans and the environment.

As an alternative to retailer trade-in or buyback programs, consumers can now recycle and/or sell their used mobile phones using self-service kiosks located in malls, retail stores or other publically accessible areas. Such kiosks are operated by ecoA™, Inc., the assignee of the present application, and are disclosed in, for example, U.S. Pat. Nos. 8,463,646; 8,423,404; 8,239,262; 8,200,533; 8,195,511; and 7,881,965, which are commonly owned by ecoA™, Inc. and are incorporated herein by reference in their entireties.

When offering to purchase used mobiles phones and/or other electronic devices from consumers, it can be important to offer the consumer a suitable price. If the price is too low, the consumer may decline the offer. Conversely, if the price is too high the recycler may be losing potential profits from the enterprise. Accordingly, it is desireable to have a system for increasing the likelihood that a device can be positively identifyied in order to establish a suitable price.

### BRIEF DESCRIPTION OF THE DRAWINGS

FIG. 1 is an isometric view of a machine configured in accordance with an embodiment of the present technology for recycling mobile phones and/or other electronic devices.

FIGS. 2A-2D are a series of isometric views of the machine of FIG. 1 with a number of exterior panels removed to illustrate operation of the machine in accordance with an embodiment of the present technology.

FIG. 3 is a flow diagram of a routine for recycling mobile phones and/or other electronic devices in accordance with an embodiment of the present technology.

FIG. 4 illustrates a communication link between a kiosk and a database that relates identifier codes to equipment types in accordance with an embodiment of the present technology.

FIG. 5 is a screen shot of a database report showing relations between different equipment types and identifier codes determined from a number of previous transactions in accordance with an embodiment of the present technology.

FIG. 6 is a screen shot of a database report showing relationships between different identifier codes and equipment types determined from a number of previous transactions in accordance with an embodiment of the present technology.

FIG. 7 is a schematic diagram illustrating various components associated with the machine of FIG. 1.

FIG. 8 is a schematic diagram of a suitable distributed computing environment for implementing various aspects of the present technology.

### DETAILED DESCRIPTION

The following disclosure describes various embodiments of systems and methods for determining prices for mobile phones and other consumer electronic devices, and for performing other operations associated with electronic device recycling. Embodiments of the methods described herein can be performed by or with consumer-operated kiosks, networked processing devices, retailer-assisted machines, and/or the like. Some embodiments of the present technology, for example, are directed to consumer-operated kiosks that can perform automatic visual and/or electrical inspections of mobile phones and/or other consumer electronic devices that are submitted to the kiosks for sale or recycling. As described in greater detail below, the visual evaluation or inspection can be performed using one or more cameras or other imaging devices, and the electrical analysis can be performed using a suitable processing device connected to the subject electronic device via, e.g., a suitable electrical connector.

Often different models of electronic devices (e.g., mobile phones) may look very similar (or even identical), even though the particular devices may in fact be very different in terms of electrical components, features, etc. This is especially true in the case of a mobile phone model that has a number of different sub-models that, although appearing visually similar, may actually have a wide variety of different electrical features. Additionally, in some instances a mobile phone may not “power up” at a recycling kiosk. In such situations, it may be very difficult for the kiosk to visually and/or electrically confirm the specific type (e.g., the make, model, sub-model, electronic features, etc.) of a particular device that is being submitted for recycling/sale. Although it may be difficult (or even impossible) to positively identify some devices taken in by the kiosk, in most instances such devices will fall into groups of visually and/or electrically similar devices. For example, visually similar groups are groups of electronic devices that look the same or similar and, as a result, are difficult for the kiosk to visually distinguish from one another. By way of example, some different models of mobile phones may have the same, or at least very similar external dimensions and features, such as the same length, width, and thickness (or height) dimensions; and/or the same placement and size of display screen, buttons, connector outlets, and/or other features. Electrically similar groups are groups of devices that share the same, or generally the same, electrical identification features. Such devices may be said to have, for example, the same or a similar “electrical fingerprint.” For example, some sub-models of mobile phones and other types of electronic devices include the same product identification number (PID) and vendor identification number (VID).

Different mobile phones within a visually/electrically similar group can have very different values. For example, some of the devices in a group may include certain features that others lack, such as larger memory, greater availability of carriers, etc., and such features can greatly affect the resale price of such devices. Accordingly, it can be important to accurately identify a mobile phone (or other electronic device) before determining a price to offer the consumer for the device. As noted above, however, in some instances consumers will submit mobile phones for sale that cannot be positively identified. When this happens, one alternative is to identify the group of visually and/or electrically similar devices to which the subject device belongs, and then offer the consumer the lowest price of any device in that group to minimize the risk of paying too much for the device. If it just so happens that the price offered to the consumer reflects the real value of the device, as the consumer perceives it, then the consumer may accept the offer. However, if it turns out that the device is actually a higher priced device within the group, then it is very likely that the consumer will reject the low price offer. This can lead to consumer dissatisfaction as well as lost profits for the kiosk operator. Conversely, if the kiosk pays too much for a device, this will also result in lost profits. Accordingly, offering a price that is closer to the actual value of the consumer's device can enhance customer satisfaction and maintain profit margins for the kiosk operator.

As discussed above, there is a need to be able to accurately identify a particular make and model of a piece of electronic equipment that is being offered for purchase. The technology described herein relates to a system that reads an identifier from the equipment and consults a database that keeps a record of the identifier and the make/model of equipment,

In one embodiment of the technology, the identifier is an IMEI/MEID code that is stored on the equipment and the database stores records of IMEI/MEID codes and particular makes/models of equipment. In another embodiment, the identifier is a TAC code that is read from the equipment and the database stores a record of TAC codes and previously determined makes/models of equipment that were the subject of previous transactions.

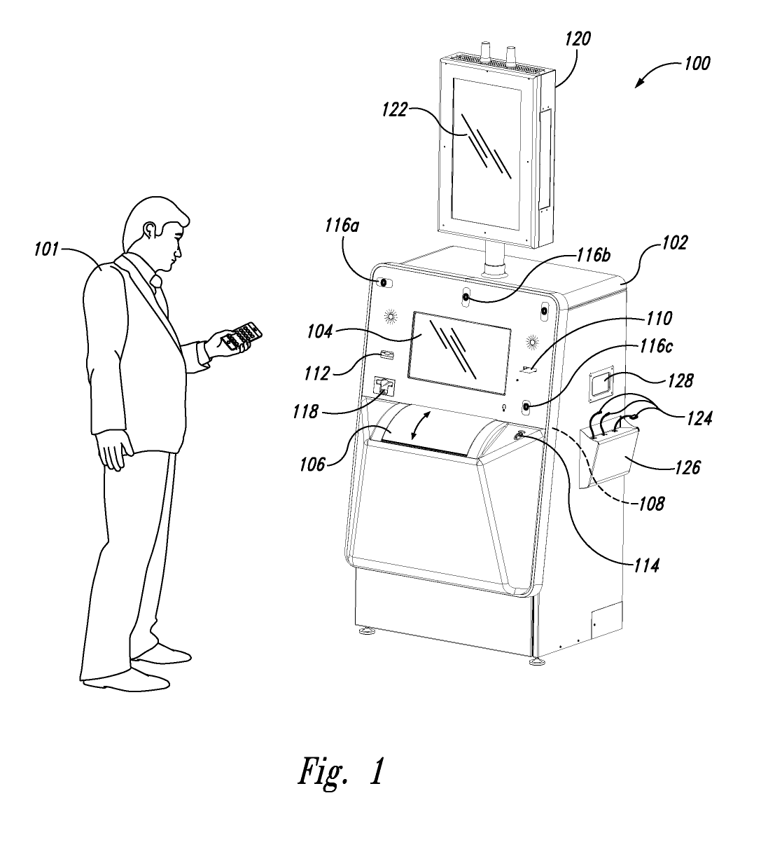

Certain details are set forth in the following description and in FIGS. 1-8 to provide a thorough understanding of various embodiments of the present technology. In other instances, well-known structures, materials, operations and/or systems often associated with smartphones and other handheld devices, consumer electronic devices, computer hardware, software, and network systems, etc. are not shown or described in detail in the following disclosure to avoid unnecessarily obscuring the description of the various embodiments of the technology. Those of ordinary skill in the art will recognize, however, that the present technology can be practiced without one or more of the details set forth herein, or with other structures, methods, components, and so forth. The terminology used below should be interpreted in its broadest reasonable manner, even though it is being used in conjunction with a detailed description of certain examples of embodiments of the technology. Indeed, certain terms may even be emphasized below; however, any terminology intended to be interpreted in any restricted manner will be specifically defined as such in this Detailed Description section.

The accompanying Figures depict embodiments of the present technology and are not intended to be limiting of its scope. The sizes of various depicted elements are not necessarily drawn to scale, and these various elements may be arbitrarily enlarged to improve legibility. Component details may be abstracted in the Figures to exclude details such as the position of components and certain precise connections between such components when such details are unnecessary for a complete understanding of how to make and use the invention.

In the Figures, identical reference numbers identify identical, or at least generally similar, elements. To facilitate the discussion of any particular element, the most significant digit or digits of any reference number refers to the Figure in which that element is first introduced. For example, element 110 is first introduced and discussed with reference to FIG. 1.

FIG. 1 is an isometric view of a kiosk 100 for recycling and/or other processing of mobile phones and other consumer electronic devices in accordance with the present technology. The term “processing” is used herein for ease of reference to generally refer to all manner of services and operations that may be performed or facilitated by the kiosk 100 on, with, or otherwise in relation to an electronic device. Such services and operations can include, for example, selling, reselling, recycling, donating, exchanging, identifying, evaluating, pricing, auctioning, decommissioning, transferring data from or to, reconfiguring, refurbishing, etc., mobile phones and other electronic devices. Although many embodiments of the present technology are described herein in the context of mobile phones, aspects of the present technology are not limited to mobile phones and generally apply to other consumer electronic devices. Such devices include, as non-limiting examples, all manner of mobile phones, smart phones, handheld devices, PDAs, MP3 players, tablet, notebook and laptop computers, e-readers, cameras, etc. In some embodiments, it is contemplated that the kiosk 100 can facilitate selling and/or otherwise processing larger consumer electronic devices, such as desktop computers, TVs, game consoles, etc., as well smaller electronic devices such as Google Glass™, smart-watches, etc. The kiosk 100 and various features thereof can be at least generally similar in structure and function to the kiosks and corresponding features described in U.S. Pat. Nos. 8,463,646; 8,423,404; 8,239,262; 8,200,533; 8,195,511; and 7,881,965; and in U.S. patent application Ser. Nos. 12/573,089; 12/727,624; 13/113,497; 12/785,465; 13/017,560; 13/438,924; 13/753,539; 13/658,825; 13/733,984; 13/705,252; 13/487,299; 13/492,835; 13/562,292; 13/658,828; 13/693,032; 13/792,030; 13/794,814; 13/794,816; 13/862,395; 13/913,408; 62/059,129; 62/059,132; 14/498,763; and 14/500,739. All of the patents and patent applications listed in the preceding sentence are commonly owned by the applicant of the present application, and they along with any other patents or patent applications identified herein are incorporated herein by reference in their entireties.

In the illustrated embodiment, the kiosk 100 is a floor-standing self-service kiosk configured for use by a user 101 (e.g., a consumer, customer, etc.) to recycle, sell, and/or perform other operations with a mobile phone or other consumer electronic device. In other embodiments, the kiosk 100 can be configured for use on a countertop or a similar raised surface. Although the kiosk 100 is configured for use by consumers, in various embodiments the kiosk 100 and/or various portions thereof can also be used by other operators, such as a retail clerk or kiosk assistant to facilitate the selling or other processing of mobile phones and other electronic devices.

In the illustrated embodiment, the kiosk 100 includes a housing 102 that is approximately the size of a conventional vending machine. The housing 102 can be of conventional manufacture from, for example, sheet metal, plastic panels, etc. A plurality of user interface devices are provided on a front portion of the housing 102 for providing instructions and other information to users, and/or for receiving user inputs and other information from users. For example, the kiosk 100 can include a display screen 104 (e.g., a liquid crystal display (“LCD”) or light emitting diode (“LED”) display screen, a projected display (such as a heads-up display or a head-mounted device), and so on) for providing information, prompts, etc., to users. The display screen 104 can include a touch screen for receiving user input and responses to displayed prompts. In addition or alternatively, the kiosk 100 can include a separate keyboard or keypad for this purpose. The kiosk 100 can also include an ID reader or scanner 112 (e.g., a driver's license scanner), a fingerprint reader 114, and one or more cameras 116 (e.g., digital still and/or video cameras, identified individually as cameras 116a-c). The kiosk 100 can additionally include output devices such as a label printer having an outlet 110, and a cash dispenser having an outlet 118. Although not identified in FIG. 1, the kiosk 100 can further include a speaker and/or a headphone jack for audibly communicating information to users, one or more lights for visually communicating signals or other information to users, a handset or microphone for receiving verbal input from the user, a card reader (e.g., a credit/debit card reader, loyalty card reader, etc.), a receipt or voucher printer and dispenser, as well as other user input and output devices. The input devices can include a touchpad, pointing device such as a mouse, joystick, pen, game pad, motion sensor, scanner, eye direction monitoring system, etc. Additionally the kiosk 100 can also include a bar code reader, QR code reader, bag/package dispenser, a digital signature pad, etc. In the illustrated embodiment, the kiosk 100 additionally includes a header 120 having a display screen 122 for displaying marketing advertisements and/or other video or graphical information to attract users to the kiosk. In addition to the user interface devices described above, the front portion of the housing 102 also includes an access panel or door 106 located directly beneath the display screen 104. As described in greater detail below, the access door is configured to automatically retract so that the user 101 can place an electronic device (e.g., a mobile phone) in an inspection area 108 for automatic inspection by the kiosk 100.

A sidewall portion of the housing 102 can include a number of conveniences to help users recycle or otherwise process their mobile phones. For example, in the illustrated embodiment the kiosk 110 includes an accessory bin 128 that is configured to receive mobile device accessories that the user wishes to recycle or otherwise dispose of. Additionally, the kiosk 100 can provide a free charging station 126 with a plurality of electrical connectors 124 for charging a wide variety of mobile phones and other consumer electronic devices.

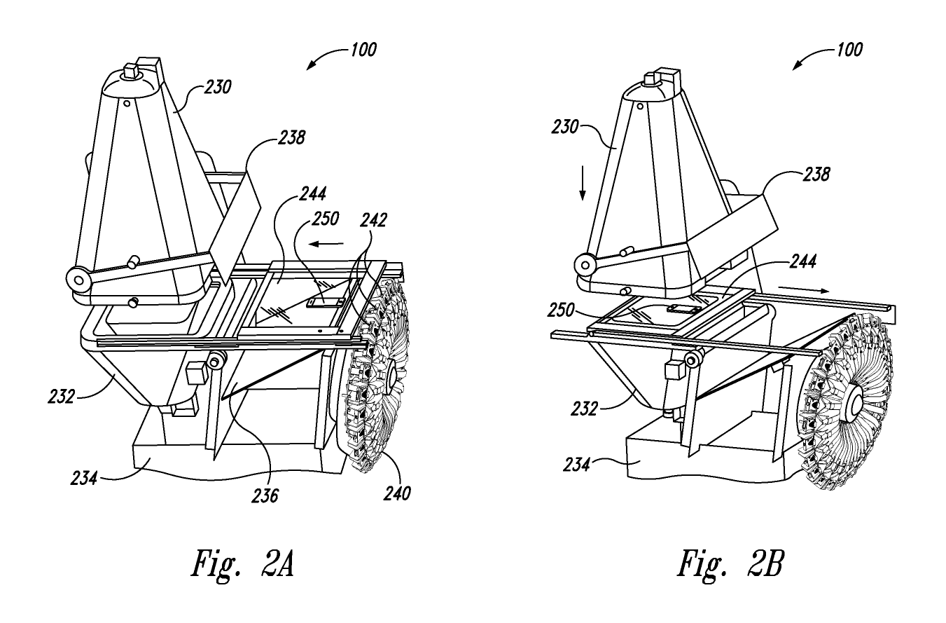

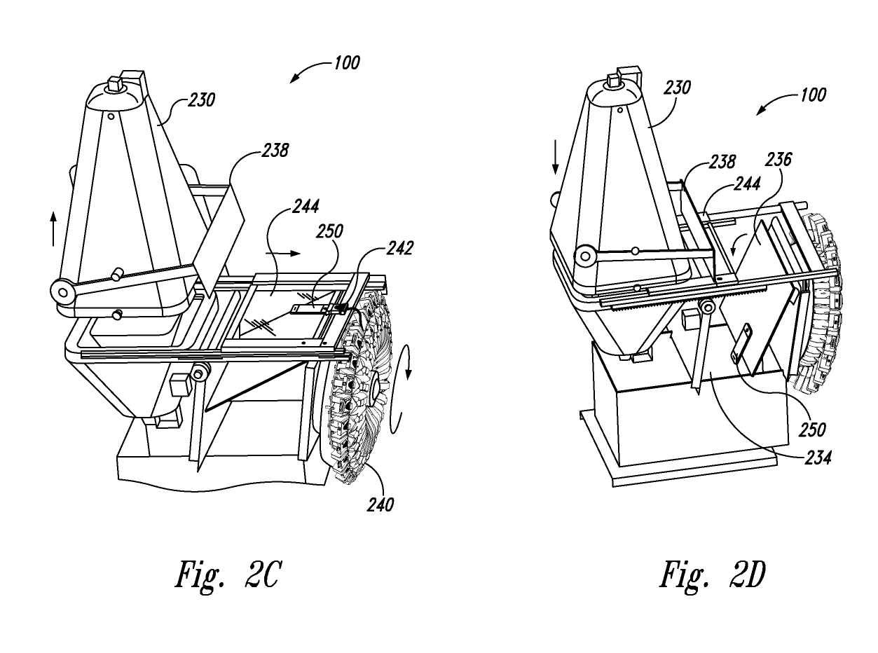

FIGS. 2A-2D are a series of isometric views of the kiosk 100 with the housing 102 removed to illustrate selected internal components configured in accordance with an embodiment of the present technology. Referring first to FIG. 2A, in the illustrated embodiment the kiosk 100 includes a connector carrier 240 and an inspection plate 244 operably disposed behind the access door 106 (FIG. 1). In the illustrated embodiment, the connector carrier 240 is a rotatable carrousel that is configured to rotate about a generally horizontal axis and carries a plurality of electrical connectors 242 (e.g., approximately 25 connectors) distributed around an outer periphery thereof. In other embodiments, other types of connector carrying devices (including both fixed and movable arrangements) can be used. In some embodiments, the connectors 242 can include a plurality of interchangeable USB connectors configured to provide power and/or exchange data with a variety of different mobile phones and/or other electronic devices. In operation, the connector carrier 240 is configured to automatically rotate about its axis to position an appropriate one of the connectors 242 adjacent to an electronic device, such as a mobile phone 250, which has been placed on the inspection plate 244 for recycling. The connector 242 can then be manually and/or automatically withdrawn from the connector carrier 240 and connected to a port on the mobile phone 250 for electrical analysis. Such analysis can include, e.g., an evaluation of the make, model, configuration, condition, etc., using one or more of the methods and/or systems described in detail in the commonly owned patents and patent applications identified herein and incorporated by reference in their entireties.

In the illustrated embodiment, the inspection plate 244 is configured to translate back and forth (on, e.g., parallel mounting tracks) to move an electronic device, such as the mobile phone 250, between a first position directly behind the access door 106 and a second position between an upper chamber 230 and an opposing lower chamber 232. Moreover, in this embodiment the inspection plate 244 is transparent, or at least partially transparent (e.g., formed of glass, Plexiglas, etc.) to enable the mobile phone 250 to be photographed and/or otherwise optically evaluated from all, or at least most viewing angles (e.g., top, bottom, sides, etc.) using, e.g., one or more cameras, mirrors, etc. mounted to or otherwise associated with the upper and lower chambers 230 and 232. When the mobile phone 250 is in the second position, the upper chamber 230 can translate downwardly to generally enclose the mobile phone 250 between the upper chamber 230 and the lower chamber 232. The upper chamber 230 is operably coupled to a gate 238 that moves up and down in unison with the upper chamber 230. As noted above, in the illustrated embodiment the upper chamber 230 and/or the lower chamber 232 can include one or more cameras, magnification tools, scanners (e.g., bar code scanners, infrared scanners, etc.) or other imaging components (not shown) and an arrangement of mirrors (also not shown) to view, photograph and/or otherwise visually evaluate the mobile phone 250 from multiple perspectives. In some embodiments, one or more of the cameras and/or other imaging components discussed above can be movable to facilitate device evaluation. The inspection area 108 can also include weight scales, heat detectors, UV readers/detectors, and the like, for further evaluation of electronic devices placed therein. The kiosk 100 can further include an angled binning plate 236 for directing electronic devices from the transparent plate 244 into a collection bin 234 positioned in a lower portion of the kiosk 100.

The kiosk 100 can be used in a number of different ways to efficiently facilitate the recycling, selling and/or other processing of mobile phones and other consumer electronic devices. Referring to FIGS. 1-2D together, in one embodiment a user wishing to sell a used mobile phone, such as the mobile phone 250, approaches the kiosk 100 and identifies the type of device the user wishes to sell in response to prompts on the display screen 104. Next, the user may be prompted to remove any cases, stickers, or other accessories from the device so that it can be accurately evaluated. Additionally, the kiosk 100 may print and dispense a unique identification label (e.g., a small adhesive-backed sticker with a quick response code (“QR code”), barcode, or other machine-readable indicia, etc.) from the label outlet 110 for the user to adhere to the back of the mobile phone 250. After this is done, the door 106 retracts and opens allowing the user to place the mobile phone 250 onto the transparent plate 244 in the inspection area 108 (FIG. 2A). The door 106 then closes and the transparent plate 244 moves the mobile phone 250 under the upper chamber 230 as shown in FIG. 2B. The upper chamber 232 then moves downwardly to generally enclose the mobile phone 250 between the upper and lower chambers 230 and 232, and the cameras and/or other imaging components in the upper and lower chambers 230 and 232 perform a visual inspection of the mobile phone 250. In some embodiments, the visual inspection can include a computer-implemented visual analysis (e.g., a three-dimensional (“3D”) analysis) performed by a processing device within the kiosk (e.g., a CPU) to confirm the identification of the mobile phone 250 (e.g. make, model and/or sub-model) and/or to evaluate or assess the condition and/or function of the mobile phone 250 and/or its various components and systems. For example, the visual analysis can include computer-implemented evaluation (e.g., a digital comparison) of images of the mobile phone 250 taken from top, side and/or end view perspectives to determine length, width, and/or height (thickness) dimensions of the mobile phone 250. The visual analysis can further include a computer-implemented inspection of a display screen on the mobile phone 250 to check for, e.g., cracks in the glass and/or other damage or defects in the LCD (e.g., defective pixels, etc.). In some embodiments, the kiosk 100 can perform the visual analysis using one or more of the methods and/or systems described in detail in the commonly owned patents and patent applications identified herein and incorporated by reference in their entireties.

Referring next to FIG. 2C, after the visual analysis is performed and the device has been identified, the upper chamber 230 returns to its upper position and the transparent plate 244 returns the mobile phone 250 to its initial position near the door 106. The display screen 104 can also provide an estimated price, or an estimated range of prices, that the kiosk 100 may offer the user for the mobile phone 250 based on the visual analysis, and/or based on user input (e.g., input regarding the type, condition, etc. of the phone 250). If the user indicates (via, e.g., input via the touch screen) that they wish to proceed with the transaction, the connector carrier 240 automatically rotates an appropriate one of the connectors 242 into position adjacent the transparent plate 244, and door 106 is again opened. The user can then be instructed (via, e.g., the display screen 104) to withdraw the selected connector 242 (and its associated wire) from the carrousel 240, plug the connector 242 into the corresponding port (e.g., a USB port) on the mobile phone 250, and reposition the mobile phone 250 in the inspection area on the transparent plate 244. After doing so, the door 106 once again closes and the kiosk 100 (e.g. the kiosk CPU) performs an electrical inspection of the device via the connector 242 to further evaluate the condition of the phone as well as specific component and operating parameters such as the memory, carrier, etc. In addition or alternatively, in some embodiments the electrical inspection can include a determination of phone manufacturer information (e.g., a vendor identification number or VID) and product information (e.g., a product identification number or PID). In some embodiments, the kiosk 100 can perform the electrical analysis using one or more of the methods and/or systems described in detail in the commonly owned patents and patent applications identified herein and incorporated by reference in their entireties.

After the visual and electronic analysis of the mobile phone 250, the user is presented with a phone purchase price via the display screen 104. If the user declines the price (via, e.g., the touch screen), a retraction mechanism (not shown) automatically disconnects the connector 242 from the mobile phone 250, the door 106 opens, and the user can reach in and retrieve the mobile phone 250. If the user accepts the price, the door 106 remains closed and the user may be prompted to place his or her identification (e.g., a driver's license) in the ID scanner 112 and provide a thumbprint via the fingerprint reader 114. As a fraud prevention measure, the kiosk 100 can be configured to transmit an image of the driver's license to a remote computer screen, and an operator at the remote computer can visually compare the picture (and/or other information) on the driver's license to an image of the person standing in front of the kiosk 100 as viewed by one or more of the cameras 116a-c (FIG. 1) to confirm that the person attempting to sell the phone 250 is in fact the person identified by the driver's license. In some embodiments, one or more of the cameras 116a-c can be movable to facilitate viewing of kiosk users, as well as other individuals in the proximity of the kiosk 100. Additionally, the person's fingerprint can be checked against records of known fraud perpetrators. If either of these checks indicates that the person selling the phone presents a fraud risk, the transaction can be declined and the mobile phone 250 returned. After the user's identity has been verified, the transparent plate 244 moves back toward the upper and lower chambers 230 and 232. As shown in FIG. 2D, however, when the upper chamber 230 is in the lower position the gate 238 permits the transparent plate 244 to slide underneath but not electronic devices carried thereon. As a result, the gate 238 knocks the mobile phone 150 off of the transparent plate 244, onto the binning plate 236 and into the bin 234. The kiosk can then provide payment of the purchase price to the user. In some embodiments, payment can be made in the form of cash dispensed from the cash outlet 118. In other embodiments, the user can receive remuneration for the mobile phone 150 in various other useful ways. For example, the user can be paid via a redeemable cash voucher, a coupon, an e-certificate, a prepaid card, a wired or wireless monetary deposit to an electronic account (e.g., a bank account, credit account, loyalty account, online commerce account, mobile wallet etc.), Bitcoin, etc.

As those of ordinary skill in the art will appreciate, the foregoing routines are but some examples of ways in which the kiosk 100 can be used to recycle or otherwise process consumer electronic devices such as mobile phones. Although the foregoing example is described in the context of mobile phones, it should be understood that the kiosk 100 and various embodiments thereof can also be used in a similar manner for recycling virtually any consumer electronic device, such as MP3 players, tablet computers, PDAs, and other portable devices, as well as other relatively non-portable electronic devices such as desktop computers, printers, devices for implementing games, entertainment or other digital media on CDs, DVDs, Blu-ray, etc. Moreover, although the foregoing example is described in the context of use by a consumer, the kiosk 100 in various embodiments thereof can similarly be used by others, such as a store clerk, to assist consumers in recycling, selling, exchanging, etc. their electronic devices.

The Figures described herein and below include representative flow diagrams and other information that depict processes used in some embodiments of the present technology. These flow diagrams may not show all functions or exchanges of data, but instead they provide an understanding of commands and data exchanged under the systems described herein. Those skilled in the relevant art will recognize that some functions or exchange of commands and data may be repeated, varied, omitted, or supplemented, and other (less important) aspects not shown may be readily implemented. Those skilled in the art will appreciate that the blocks shown in the flow diagrams discussed below may be altered in a variety of ways. For example, while processes or blocks are presented in a given order, alternative implementations may perform routines in a different order, and some processes or blocks may be rearranged, deleted, moved, added, subdivided, combined, and/or modified to provide alternative or sub-combinations. Each of these processes or blocks may be implemented in a variety of different ways. Also, although processes or blocks are at times shown as being performed in series, these processes or blocks may instead be performed or implemented in parallel, or may be performed at different times. The steps depicted in the flow diagrams and/or represented by other tables, formulas, etc. can themselves include a sequence of operations that need not be described herein. Those of ordinary skill in the art can create source code, microcode, program logic arrays and/or or computer-readable instructions to implement the depicted steps and routines based on the flowcharts and the detailed description provided herein. The routines and portions thereof can be stored in non-volatile memory that forms part of a processor contained in the kiosk 100 or otherwise associated with the kiosk 100 (e.g., a remote processor operably connected to the kiosk 100 via a wired/wireless communication link, etc.), or they can be stored in removable media, such as disks, or hardwired or preprogrammed in chips, such as EEPROM semiconductor chips.

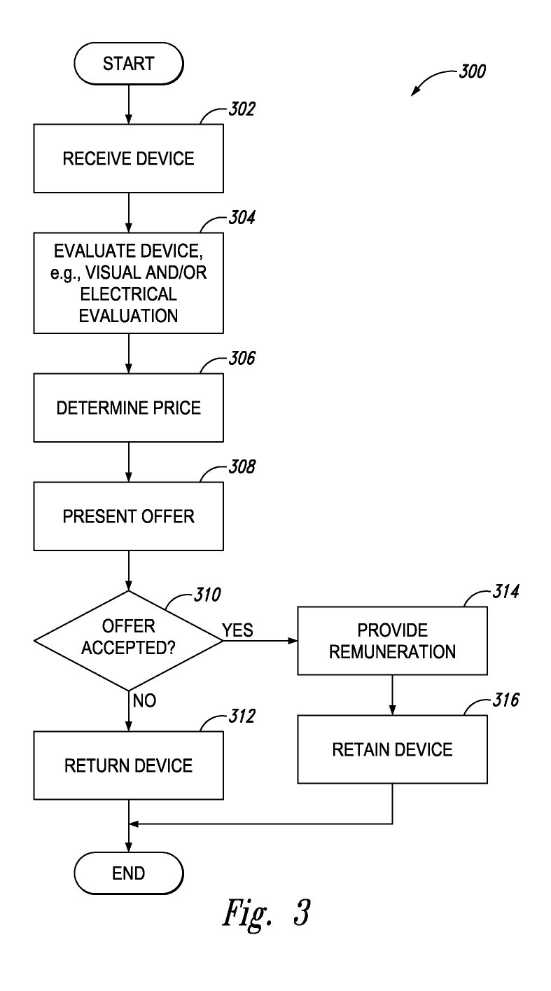

FIG. 3 is a flow diagram of a routine 300 that can be performed by the kiosk 100 for purchasing devices, e.g., mobile phones and/or other electronic devices, from users in accordance with an embodiment of the present technology. The routine can be executed by a processing device in accordance with computer-executable instructions stored on memory. In step or block 302, the routine receives the device from the user (e.g., in the inspection area 108 of the kiosk 100 (FIG. 1)). In block 304, the routine performs an evaluation, e.g., a visual and/or electrical inspection of the device, to determine various information about the device that can affect the device value. Such information can include, for example, the make, model, sub-model of the device, the device features (e.g., memory size, cell service carrier, etc.), device operability, device charge and/or rechargeability, physical condition, display function and condition, etc. After the device has been evaluated, the routine proceeds to block 306 to determine a price to offer the user for the device. In block 308, the routine presents the offer to the user (via, e.g., a textual message on the display screen 104, an audio speaker, etc.). In decision block 310, the routine determines if the user has accepted the offer price (by, e.g., providing input via a touch screen, key pad, microphone, etc. operably coupled to the kiosk 100). If the user declines the offer, the routine proceeds to block 312 and returns the device to the user. Conversely, if the user accepts the offer, the routine proceeds to block 314 and provides remuneration to the user in the amount of the purchase price. Such remuneration or payment can be in the form of, e.g., cash, a voucher redeemable for cash, merchandise, services, etc., electronic value (e.g., bitcoin, e-certificates, credit to electronic payment account, etc.), credit (e.g., a prepaid credit card, debit card, gift card, etc.), coupons, loyalty points, and/or other forms of value. In block 316, the routine retains the device (e.g., in the collection bin 234 of the kiosk 100) and the routine ends.

As discussed above, it can be important to offer the user what the user perceives as a “fair” price for the device to incentivize the user to sell the device. Moreover, it can also be important to determine a price that provides the kiosk operator (retailer, or other commercial enterprise) with a sufficient profit margin for providing the device recycling service. In some instances, however, it can be difficult to correctly identify and/or fully evaluate a mobile phone or other electronic device with a computer-controlled kiosk or similar machine for various reasons. For example, in the case of a mobile phone, the phone may not “power up” when connected to the kiosk. If the phone does not power up, then it may not be possible to electrically evaluate the phone with a suitably programmed processing device to obtain important information such as, for example, the PID, VID, carrier information, memory size, whether the phone is locked (and/or can be unlocked), LCD integrity, etc. Without a sufficient understanding of the physical and electrical aspects and/or features of a given device, it can be difficult to accurately determine a fair price for the device that is mutually beneficial to the seller (e.g., the kiosk user) and the buyer (e.g., the kiosk operator, retailer, etc.).

As noted above, many mobile phones and other electronic devices (e.g., tablets, notebooks, laptops, MP3 players, etc.) fall into or belong to groups of devices that have similar physical, visual, and/or electrical features. For example, often two or more mobile phones may have the same, or very close to the same, visual appearance (e.g., the same length, width, height/thickness, display screen shape, placement of buttons and/or connector ports, etc.). Similarly, many mobile phones and other electronic devices have equivalent or at least very similar electronic features and characteristics. For example, some mobile phone sub-models within device families (e.g., Samsung Galaxy S3 and S4 smartphones) may have the same “electrical fingerprint” or “electrical identification,” such as the same PID/VID, and/or portions of the IMEI or MEID numbers may be the same. Accordingly, one aspect of the present technology is the recognition that mobile phones and other consumer electronic devices can be arranged into similar groups, such as visually similar groups and electrically similar groups.

As discussed above, in some instances a consumer or other user may wish to sell a mobile phone or other electronic device via the kiosk 100 or other machine (e.g., an operator-assisted counter-top machine), and the kiosk 100 may not be able to sufficiently identify the device type. In these instances, the kiosk operator may be inclined to offer the user a price for the device that is too low, because of the risk that the device could in fact be the lowest-priced device in the visually similar and/or electrically similar group to which the device belongs. However, the user may in fact have submitted a higher-priced device to the kiosk 100 for sale. If the user has in fact offered to sell such a device, the user would likely decline a lower price offer. However, if instead the user was offered a higher price, the user would be more likely to accept the offer. Accordingly, embodiments of the present technology may enable the kiosk 100 to complete more purchase transactions and therefore recycle more mobile phones and other electronic devices in an efficient way than might otherwise be possible using other device pricing methods and systems.

As discussed above, there are instances where a correct identification of the make/model and capabilities of a phone or other electronic device is difficult from an electrical and/or visual inspection alone. For example, many phones that appear very similar may have different memory amounts or may have different processor versions. The best way to positively identify a device is based on a code or other identifier that is given to the device upon its manufacture and that indicates its make and model. In one embodiment of the disclosed technology, the code is the device's IMEI/MEID. This number uniquely identifies the device and can be used to identify its manufacturer, model number, memory size and communication protocol. IMEI/MEID numbers are typically allocated in blocks by a global issuing body such the GSMA (Global System for Mobile Communications Association) to a particular manufacturer. The manufacturer assigns a model number to a particular portion of the IMEI/MEID such as its first eight digits (often referred to a Type Allocation Code or TAC code). The mapping of the device specifications to a particular TAC is returned to the GMSA or other issuing body. The GSMA keeps a database that relates the TAC codes to the model information. An IMEI/MEID number that is read from a phone or other electronic device that was offered for recycling can be used by a kiosk to identify the manufacturer, model number, communication protocol and other specifications associated with the device.

In one embodiment, the kiosk is configured to query the GSMA database with an IMEI/MEID that was read from a phone or other electronic device. The database returns information about the device to the kiosk in response to the query. The kiosk uses the information to ensure that the device is correctly identified and a fair price is offered. If the type of device does not match the type of device that was determined by the kiosk from the visual or electronic inspection, the user may be offered a different amount for the device. In one embodiment, the offer may be for a lower amount to be paid immediately and an additional amount to be paid when the type of device is confirmed by further physical and electrical inspection. If the information indicates that a device was misidentified, the information is used to further refine the device-identifying algorithm in order to better identify similar devices in the future.

The query can be sent directly from the kiosk to the GSMA or other governing organization via a wired or wireless communication link. In other embodiments, copies of the database are obtained and stored at a central or a regional processing location for the devices that are collected by the kiosks. In yet another embodiment, the database is stored locally on the kiosk itself. Updates to the database are periodically made so that the information about the latest models and specifications for devices is available to the kiosks as needed.

In one embodiment, the kiosk receives the IMEI/MIED by prompting the user to enter it via a keyboard. Alternatively voice recognition or other input means, such as a barcode scanner, are used to receive the IMEI/MEID. In other embodiments, the IMEI/MIED is determined by electronically reading it off the device.

In an alternative embodiment, a code made up from portions of the IMEI/MEID or other identifiers uniquely associated with the particular electronic device is used to query the database for the make/model information. For example, all or a portion of the device's serial number could be used. Similarly, a code could be produced from an input code comprising all or a portion of the device's IMEI/MEID, serial number or the like, similar to the way that keys are generated for encryption.

If a user enters an indication of a type of device and the kiosk determines from the information received from the database that the device does not match the description given, the user may be prompted to reenter their description of the device or the kiosk may make a revised offer for the device.

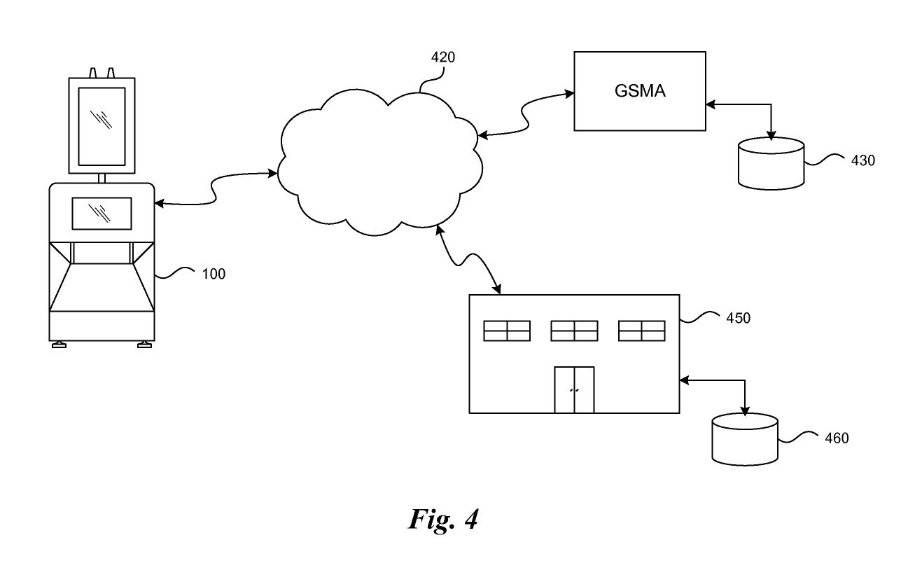

FIG. 4 shows an embodiment of the disclosed technology that includes a kiosk 100 connected by a communication link 420 to the GSMA that maintains a database 430 of the IMEI/MEID to device specifications mappings. The kiosk 100 sends a query that includes an IMEI/MEID to the database 430. The database 430 returns information about the device based on the IMEI/MEID supplied. The information is used by the kiosk 100 to confirm that a correct offer for the device is being made. In another embodiment, the kiosk 100 sends a query to a regional processing facility 450 that maintains a database 460 of the IMEI/MEID to device specifications mappings.

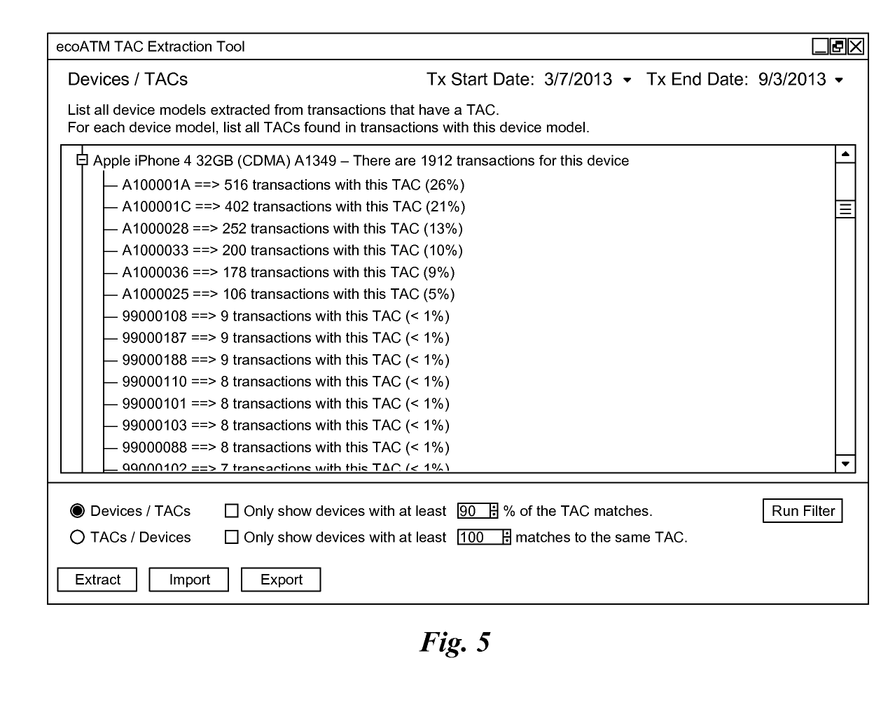

In some embodiments, the kiosks or central/regional processing facilities do not have access to the IMEI/MIED to device specifications database. In another embodiment, the central/regional processing locations therefore maintain a database that maps transactions involving confirmed device types to different TAO numbers. FIG. 5 shows one example of the type of information that is maintained by the database. The database uses a unique TAO code that corresponds to a particular type of electronic device and specifications. Records are kept in the database of each transaction performed at all the kiosks in the system. Each record may include, among other things, the TAO code for the type of electronic device used in the transaction, the price paid, the location of the transaction and other information.

Reports can be run from the database as shown in FIG. 5. With the database, a user can run queries for all transactions involving a particular type of electronic equipment, such as the Apple iPhone 4 32 GB (CDMA) A1349. In the example shown, there were 1912 transactions stored in the database for this type of device. 516 or 26% of the transactions were associated with a TAO code of A100001A, while 402 or 21% of the transactions were associated with a TAO code A100001C etc. The database can be used to determine if the device and TAO code are properly matched. For example, if a TAO code as determined by the first eight digits of an IMEI/MIED is 99000108 and that code is associated with less than 1% of transactions involving the Apple iPhone 4 32 GB (CDMA) A1349, then the kiosk will determine that the phone is most likely not this type of device and will prompt a user to re-enter an identification for the device or will offer a different price for the phone.

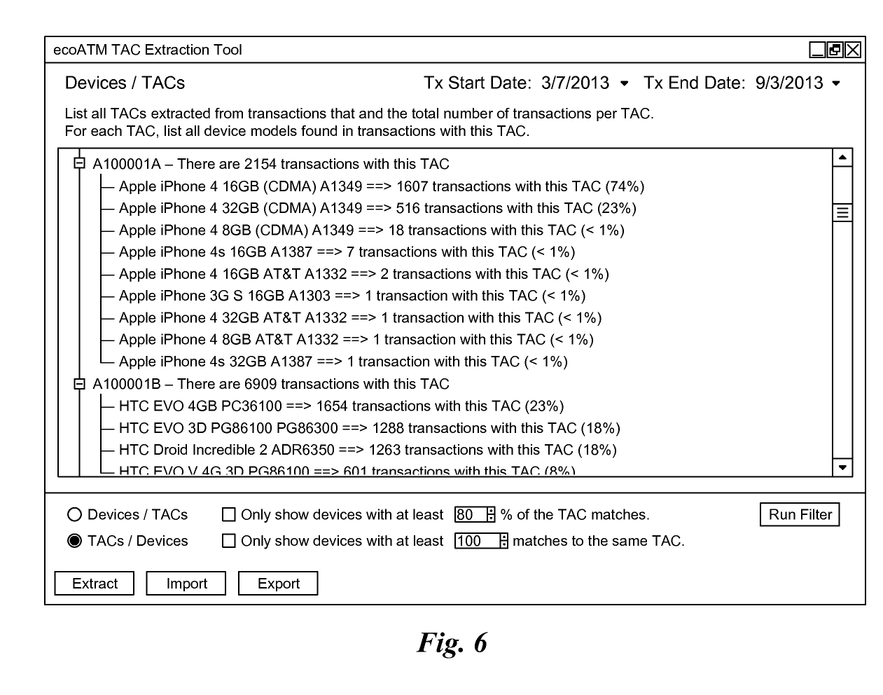

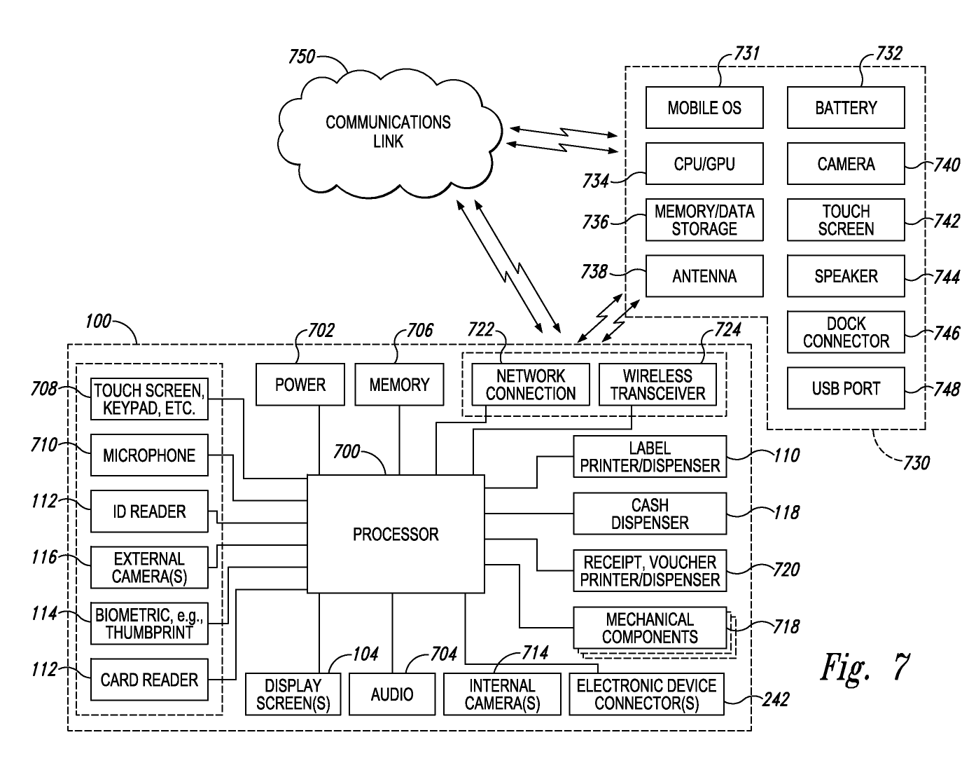

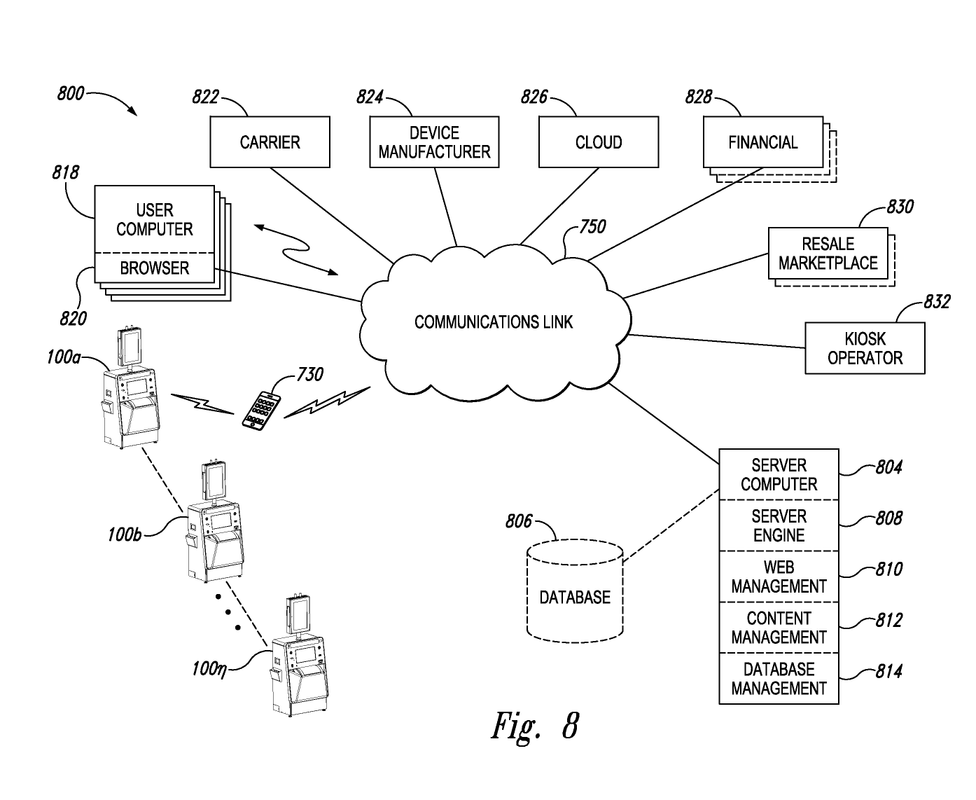

As shown in FIG. 6, the database can also be queried to determine the types of devices most often associated with a particular TAO code. In the example shown, the TAO code A100001A is associated with an Apple iPhone 4 16 GB (CDMA) A1349 74% of the time and an Apple iPhone 4 32 GB (CDMA) A1349 23% of the time. Therefore, the kiosk may factor this information into account when determining the correct offer price for the phone. For example, if the kiosk detects an A100001A TAO number and cannot definitively determine that the phone is a 32 GB version by visual or electrical inspection, a lesser price may be offered for the phone or a lesser initial price with an additional amount to be paid in the future can be offered once the exact memory capacity of the phone is determined.

FIG. 7 provides a schematic representation of an architecture of the kiosk 100 in accordance with an embodiment of the present technology. In the illustrated embodiment, the kiosk 100 includes a suitable processor or central processing unit (“CPU”) 700 that controls operation of the kiosk 100 in accordance with computer-readable instructions stored on system memory 706. The CPU 700, for example, can control performance of the various pricing routines and/or generation of the weighted average prices. The CPU 700 may be any logic processing unit, such as one or more CPUs, digital signal processors (DSPs), application-specific integrated circuits (ASICs), etc. The CPU 700 may be a single processing unit or multiple processing units in a device or distributed across multiple devices. The CPU 700 is connected to the memory 706 and may be coupled to other hardware devices, for example, with the use of a bus (e.g., a PCI Express or Serial ATA bus). The CPU 700 can include, by way of example, a standard personal computer (“PC”) (e.g., a DELL OPTIPLEX 780 or 7010 PC) or other type of embedded computer running any suitable operating system, such as Linux, Windows, Android, iOS, MAC OS, or an embedded real-time operating system. In some embodiments, the CPU 700 can be a small form factor PC with integrated hard disk drive (“HDD”) or solid-state drive (“SSD”) and universal serial bus (“USB”) or other ports to communicate with the other components of the kiosk 100. In other embodiments, the CPU 700 can include a microprocessor with a standalone motherboard that interfaces with a separate HDD. The memory 706 can include read-only memory (ROM) and random access memory (RAM) or other storage devices, such as disk drives or SSDs, that store the executable applications, test software, databases and other software required to, for example, implement the various routines described herein (e.g., those described with reference to FIG. 3), control kiosk components, process electronic device information and data (to, e.g., evaluate device make, model, condition, pricing, etc.), communicate and exchange data and information with remote computers and other devices, etc.

The CPU 700 can provide information and instructions to kiosk users via the display screen 104 and/or an audio system (e.g., a speaker) 704. The CPU 700 can also receive user inputs via, e.g., a touch screen 708 associated with the display screen 104, a keypad with physical keys, and/or a microphone 710. Additionally, the CPU 700 can receive personal identification and/or biometric information associated with users via the ID reader 112, one or more of the external cameras 116, and/or the fingerprint reader 114. In some embodiments, the CPU 700 can also receive information (such as user identification and/or account information) via a card reader 112 (e.g., a debit, credit, or loyalty card reader having, e.g., a suitable magnetic stripe reader, optical reader, etc.). The CPU 700 can also control operation of the label dispenser 110 and systems for providing remuneration to users, such as the cash dispenser 118 and/or a receipt or voucher printer and an associated dispenser 720.

As noted above, the kiosk 100 additionally includes a number of electronic, optical and electromechanical devices for electrically, visually and/or physically analyzing electronic devices placed therein for recycling. Such systems can include one more internal cameras 714 for visually inspecting electronic devices to, e.g., determine the external dimensions and condition, and one or more of the electrical connectors 242 (e.g., USB connectors) for, e.g., powering up electronic devices and performing electronic analyses. As noted above, the cameras 714 can be operably coupled to the upper and lower chambers 230 and 232, and the connectors 242 can be movably and interchangeably carried by the carrousel 240 (FIGS. 2A-2D). The kiosk 100 further includes a plurality of mechanical components that are electronically actuated for carrying out the various functions of the kiosk 100 during operation. The mechanical components 718 can include, for example, the inspection area access door 106 and one or more of the movable components (e.g. the inspection plate 244, the upper and lower chambers 230 and 232, etc.) operably disposed within the inspection area 108 (FIG. 1). The kiosk 100 further includes power 702, which can include battery power and/or facility power for operation of the various electrical components associated with kiosk operation.

In the illustrated embodiment, the kiosk 100 further includes a network connection 722 (e.g., a wired connection, such as an Ethernet port, cable modem, FireWire cable, Lightning connector, USB port, etc.) suitable for communication with, e.g., all manner of remote processing devices via a communication link 750, and a wireless transceiver 724 (e.g., including a Wi-Fi access point, Bluetooth transceiver, near-field communication (NFC) device, and/or wireless modem or cellular radio utilizing GSM, CDMA, 3G and/or 4G technologies) for data communications suitable for communication with, e.g., all manner of remote processing devices via the communication link 750 and/or directly via, e.g., a wireless peer-to-peer connection. For example, the wireless transceiver 724 can facilitate wireless communication with handheld devices, such as a mobile device 730 (e.g., a smartphone) either in the proximity of the kiosk 100 or remote therefrom. By way of example only, in the illustrated embodiment the mobile device 730 can include one or more features, applications and/or other elements commonly found in smartphones and other known mobile devices. For example, the mobile device 730 can include a CPU and/or a graphics processing unit (“GPU”) 734 for executing computer readable instructions stored on memory 736. In addition, the mobile device 730 can include an internal power source or battery 732, a dock connector 746, a USB port 748, a camera 740, and/or well-known input devices, including, for example, a touch screen 742, a keypad, etc. In many embodiments, the mobile device 730 can also include a speaker 744 for two-way communication and audio playback. In addition to the foregoing features, the mobile device 730 can include a mobile operating system (OS) 731 and/or a device wireless transceiver that may include one or more antennas 738 for wirelessly communicating with, for example, other mobile devices, websites, and the kiosk 100. Such communication can be performed via, e.g., the communication link 750 (which can include the Internet, public and private intranet, a local or extended Wi-Fi network, cell towers, the plain old telephone system (POTS), etc.), direct wireless communication, etc.

Unless described otherwise, the construction and operation of the various components shown in FIG. 7 are of conventional design. As a result, such components need not be described in further detail herein, as they will be readily understood by those skilled in the relevant art. In other embodiments, the kiosk 100 and/or the mobile device 730 can include other features that may be different from those described above. In still further embodiments, the kiosk 100 and/or the mobile device 730 can include more or fewer features similar to those described above.

FIG. 8 is a schematic diagram of a suitable network environment for implementing various aspects of an electronic device recycling system 800 configured in accordance with embodiments of the present technology. In the illustrated embodiment, a plurality of the kiosks 100 (identified individually as kiosks 100a-100n) can exchange information with one or more remote computers (e.g., one or more server computers 804) via the communication link 750. Although the communication link 750 can include a publically available network (e.g., the Internet with a web interface), a private communication link, such as an intranet or other network may also be used. Moreover, in various embodiments the individual kiosk 100 can be connected to a host computer (not shown) that facilitates the exchange of information between the kiosks 100 and remote computers, other kiosks, mobile devices, etc.

The server computer 804 can perform many or all of the functions for receiving, routing and storing electronic messages, such as webpages, audio signals and electronic images necessary to implement the various electronic transactions described herein. For example, the server computer 804 can retrieve and exchange web pages and other content with an associated database or databases 806. In some embodiments, the database 806 can include information related to mobile phones and/or other consumer electronic devices. Such information can include, for example, make, model, serial number, IMEI, MEID, carrier plan information, pricing information, owner information, etc., as well as dimensional information (size, shape, location of displays, ports, etc.) and other visual information (e.g., logo shapes, sizes, locations, etc.) associated with known devices, such as particular device models, sub-models, etc. In various embodiments the server computer 804 can also include a server engine 808, a web page management component 810, a content management component 812, and a database management component 814. The server engine 808 can perform the basic processing and operating system level tasks associated with the various technologies described herein. The webpage management component 810 can handle creation and/or display and/or routing of web or other display pages. The content management component 812 can handle many of the functions associated with the routines described herein. The database management component 814 can perform various storage, retrieval and query tasks associated with the database 806, and can store various information and data such as animation, graphics, visual and audio signals, etc. Those of ordinary skill in the art will appreciate that many of the routines and/or portions thereof and other functions and methods described above can be performed by the kiosk 100 (e.g., the processor 700), the server computer 804, or both.

In the illustrated embodiment, the kiosks 100 can also be operably connected to a plurality of other remote devices and systems via the communication link 750. For example, the kiosks 100 can be operably connected to a plurality of user devices 818 (e.g., personal computers, laptops, handheld devices, etc.) having associated browsers 820. Similarly, as described above the kiosks 100 can each include wireless communication facilities for exchanging digital information with mobile devices, such as the mobile device 730. The kiosks 100 and/or the server computer 804 are also operably connectable to a series of remote computers for obtaining data and/or exchanging information with necessary service providers, financial institutions, device manufactures, authorities, government agencies, etc. For example, the kiosks 100 and the server computer 804 can be operably connected to one or more cell carriers 822, one or more device manufacturers 824 (e.g., mobile phone manufacturers), one or more electronic payment or financial institutions 828, one or more databases (e.g., the GSMA International Mobile Equipment Identity Database, etc.), and one or more computers and/or other remotely located or shared resources associated with cloud computing 826. The financial institutions 828 can include all manner of entity associated with conducting financial transactions, including banks, credit/debit card facilities, online commerce facilities, online payment systems, virtual cash systems, money transfer systems, etc.

In addition to the foregoing, the kiosks 100 and the server computer 804 can also be operably connected to a resale marketplace 830 and a kiosk operator 832. The resale marketplace 830 represents a system of remote computers and/or services providers associated with the reselling of consumer electronic devices through both electronic and brick-and-mortar channels. Such entities and facilities can be associated with, for example, online auctions for reselling used electronic devices as well as for establishing market prices for such devices. The kiosk operator 832 can be a central computer or system of computers for controlling all manner of operation of the network of kiosks 100. Such operations can include, for example, remote monitoring and facilitating of kiosk maintenance (e.g., remote testing of kiosk functionality, downloading operational software and updates, etc.), servicing (e.g., periodic replenishing of cash and other consumables), performance, etc. In addition, the kiosk operator 832 can further include one or more display screens operably connected to cameras located at each of the kiosks 100 (e.g., one or more of the cameras 116 described above with reference to FIG. 1). This remote viewing capability enables operator personnel to verify user identification and/or make other visual observations at the kiosks 100 in real-time during transactions, as described above with reference to FIG. 1.

The foregoing description of the electronic device recycling system 800 illustrates but one possible network system suitable for implementing the various technologies described herein. Accordingly, those of ordinary skill in the art will appreciate that other systems consistent with the present technology can omit one or more of the facilities described in reference to FIG. 8 or may include one or more additional facilities not described in detail in FIG. 8.

Those of ordinary skill in the art will appreciate that the routines and other functions and methods described above can be performed by various processing devices, such as the kiosk processor 700 (FIG. 7), the server computer 804 (FIG. 8), or both. The processes can be implemented as an application specific integrated circuit (ASIC), by a digital signal processing (DSP) integrated circuit, through conventional programmed logic arrays or circuit elements. While many of the embodiments are shown and described as being implemented in hardware (e.g., one or more integrated circuits designed specifically for a task), such embodiments could equally be implemented in software and be performed by one or more processors. Such software can be stored on any suitable computer-readable medium, such as microcode stored in a semiconductor chip, on a computer-readable disk, or downloaded from a server and stored locally at a client.

The kiosks 100, mobile devices 730, server computers 804, user computers and/or other user devices 818, etc. may include one or more central processing units or other logic-processing circuitry, memory, input devices (e.g., keyboards and pointing devices), output devices (e.g., display devices and printers), and storage devices (e.g., magnetic, solid state, fixed and floppy disk drives, optical disk drives, etc.). Such computer devices may include other program modules such as an operating system, one or more application programs (e.g., word processing or spread sheet applications), and the like. The user computers may include wireless computers, such as mobile phones, personal digital assistants (PDAs), palm-top computers, etc., which communicate with the Internet via a wireless link. The computers may be general-purpose devices that can be programmed to run various types of applications, or they may be single-purpose devices optimized or limited to a particular function or class of functions. Aspects of the invention may be practiced in a variety of other computing environments.

While the Internet is shown, a private network, such as an intranet may likewise be used herein. The network may have a client-server architecture, in which a computer is dedicated to serving other client computers, or it may have other architectures such as peer-to-peer, in which one or more computers serve simultaneously as servers and clients. A database or databases, coupled to the server computer(s), stores much of the web pages and content exchanged between the user computers. The server computer(s), including the database(s), may employ security measures to inhibit malicious attacks on the system and preserve the integrity of the messages and data stored therein (e.g., firewall systems, message encryption and/or authentication (e.g., using transport layer security (TLS) or secure socket layers (SSL)), password protection schemes, encryption of stored data (e.g., using trusted computing hardware), and the like).

One skilled in the relevant art will appreciate that the concepts of the invention can be used in various environments other than location based or the Internet. In general, a display description may be in HTML, XML or WAP format, email format or any other format suitable for displaying information (including character/code-based formats, algorithm-based formats (e.g., vector generated), and bitmapped formats). Also, various communication channels, such as local area networks, wide area networks, or point-to-point dial-up connections, may be used instead of the Internet. The system may be conducted within a single computer environment, rather than a client/server environment. Also, the user computers may comprise any combination of hardware or software that interacts with the server computer, such as television-based systems and various other consumer products through which commercial or noncommercial transactions can be conducted. The various aspects of the invention described herein can be implemented in or for any e-mail environment.

Although not required, aspects of the invention are described in the general context of computer-executable instructions, such as routines executed by a general-purpose data processing device, e.g., a server computer, wireless device or personal computer. Those skilled in the relevant art will appreciate that aspects of the invention can be practiced with other communications, data processing, or computer system configurations, including Internet appliances, hand-held devices (including personal digital assistants (PDAs)), wearable computers, all manner of cellular or mobile phones (including Voice over IP (VoIP) phones), dumb terminals, media players, gaming devices, multi-processor systems, microprocessor-based or programmable consumer electronics, set-top boxes, network PCs, mini-computers, mainframe computers, and the like. Indeed, the terms “computer,” “server,” “host,” “host system,” and the like, are generally used interchangeably herein, and refer to any of the above devices and systems, as well as any data processor. Input devices may include a touchpad, keyboard and/or a pointing device such as a mouse. Other input devices are possible such as a microphone, joystick, pen, game pad, scanner, digital camera, video camera, and the like. The data storage devices may include any type of computer-readable media that can store data accessible by a computer, such as magnetic hard and floppy disk drives, optical disk drives, magnetic cassettes, tape drives, flash memory cards, digital video disks (DVDs), Bernoulli cartridges, RAMs, ROMs, smart cards, etc. Indeed, any medium for storing or transmitting computer-readable instructions and data may be employed, including a connection port to a network such as a local area network (LAN), wide area network (WAN) or the Internet.

Aspects of the invention can be embodied in a special purpose computer or data processor that is specifically programmed, configured, or constructed to perform one or more of the computer-executable instructions explained in detail herein. While aspects of the invention, such as certain functions, are described as being performed exclusively on a single device, the invention can also be practiced in distributed environments where functions or modules are shared among disparate processing devices, which are linked through a communications network, such as a Local Area Network (LAN), Wide Area Network (WAN), or the Internet. In a distributed computing environment, program modules may be located in both local and remote memory storage devices.

Aspects of the invention may be stored or distributed on tangible computer-readable media, including magnetically or optically readable computer discs, hard-wired or preprogrammed chips (e.g., EEPROM semiconductor chips), nanotechnology memory, biological memory, or other data storage media. The data storage devices may include any type of computer-readable media that can store data accessible by a computer, such as magnetic hard and floppy disk drives, optical disk drives, magnetic cassettes, tape drives, flash memory cards, DVDs, Bernoulli cartridges, RAM, ROMs, smart cards, etc. Indeed, any medium for storing or transmitting computer-readable instructions and data may be employed, including a connection port to a network such as a LAN, WAN, or the Internet. Alternatively, computer implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). The terms “memory” and “computer-readable storage medium” include any combination of temporary, persistent, and/or permanent storage, e.g., ROM, writable memory such as RAM, writable non-volatile memory such as flash memory, hard drives, solid state drives, removable media, and so forth, but do not include a propagating signal per se.

The above Detailed Description of examples and embodiments of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. References throughout the foregoing description to features, advantages, or similar language do not imply that all of the features and advantages that may be realized with the present technology should be or are in any single embodiment of the invention. Rather, language referring to the features and advantages is understood to mean that a specific feature, advantage, or characteristic described in connection with an embodiment is included in at least one embodiment of the present technology. Thus, discussion of the features and advantages, and similar language, throughout this specification may, but do not necessarily, refer to the same embodiment. Furthermore, the described features, advantages, and characteristics of the present technology may be combined in any suitable manner in one or more embodiments. One skilled in the relevant art will recognize that the present technology can be practiced without one or more of the specific features or advantages of a particular embodiment. In other instances, additional features and advantages may be recognized in certain embodiments that may not be present in all embodiments of the present technology.

Any patents and applications and other references noted above, including any that may be listed in accompanying filing papers, are incorporated herein by reference. Aspects of the invention can be modified, if necessary, to employ the systems, functions, and concepts of the various references described above to provide yet further implementations of the invention.

Unless the context clearly requires otherwise, throughout the description and the claims, the words “comprise,” “comprising,” and the like, are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The teachings of the invention provided herein can be applied to other systems, not necessarily the system described above. The elements and acts of the various examples described above can be combined to provide further implementations of the invention. Some alternative implementations of the invention may include not only additional elements to those implementations noted above, but also may include fewer elements. Further any specific numbers noted herein are only examples—alternative implementations may employ differing values or ranges.

While the above description describes various embodiments of the invention and the best mode contemplated, regardless how detailed the above text, the invention can be practiced in many ways. Details of the system may vary considerably in its specific implementation, while still being encompassed by the present disclosure. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

From the foregoing, it will be appreciated that specific embodiments of the invention have been described herein for purposes of illustration, but that various modifications may be made without deviating from the spirit and scope of the various embodiments of the invention. Further, while various advantages associated with certain embodiments of the invention have been described above in the context of those embodiments, other embodiments may also exhibit such advantages, and not all embodiments need necessarily exhibit such advantages to fall within the scope of the invention. Accordingly, the invention is not limited, except as by the appended claims. Although certain aspects of the invention are presented below in certain claim forms, the applicant contemplates the various aspects of the invention in any number of claim forms. Accordingly, the applicant reserves the right to pursue additional claims after filing this application to pursue such additional claim forms, in either this application or in a continuing application.

I/We claim:

1. A system for purchasing electronic devices from consumers, the system comprising:
an inspection area for receiving electronic devices;
a processing device; and
a computer-readable medium that contains computer-executable instructions configured to cause the processing device to operate the system according to a method that comprises:
obtaining a code that identifies the type of electronic device that is received in the inspection area;
querying a database with the code to determine information about the type of device that is received in the inspection area;
receiving information about of the type of electronic device from the database that relates codes to different types of electronic devices; and
determining a price to offer a user for the electronic device using the information received from the database.

2. The system of claim 1 wherein the code is obtained by:
prompting the user to provide the code; and
receiving the code from a user.

3. The system of claim 1 wherein the code is obtained by:
reading the code from the electronic device.

4. A system for purchasing electronic devices from consumers, the system comprising:
an inspection area for receiving electronic devices;
a processing device; and
a computer-readable medium that contains computer-executable instructions configured to cause the processing device to operate the system according to a method that comprises:
obtaining a code that identifies the type of electronic device that is received in the inspection area;
querying a database with the code;
receiving information about the type of electronic device in the inspection area from the database that relates codes to different electronic devices identified in previous transactions to purchase other electronic devices; and
determining a price to offer a user for the electronic device using the received information.

5. The system of claim 4, wherein the code is a TAO code determined from an IMEI/MEID number of the electronic device.

6. A system for assisting in the purchase of electronic devices from a consumer, the system comprising:
a memory for storing a database that relates codes to different makes/models of electronic devices used in previous transactions involving the devices;
a processor that is configured to execute instructions;
a computer-readable medium that contains computer-executable instructions that when executed cause the processor to:
receive a code that identifies a type of electronic device from a kiosk that has obtained the code for an electronic device that is being offered for purchase;
querying a database that relates codes to different types of electronic devices that were identified in previous transactions for the purchase of electronic devices; and
transmitting information about the electronic device associated with the received code to the kiosk.

7. The system of claim 6, wherein the database keeps a record of the number of transactions completed for a particular type of electronic device and a code associated with the device.

8. The system of claim 6, wherein the code is a TAO code comprising a number of digits obtained from an IMEI/MEID of an electronic device.
